(19) United States
(12) Patent Application Publication
(10) Pub. No.: US 2002/0069224 A1
(43) Pub. Date: Jun. 6, 2002

(54) Markup language document conversion apparatus and method

(76) Inventors: Arito Asai, Asaka-shi (JP); Mikio Watanabe, Asaka-shi (JP)

Correspondence Address: McGinn & Gibb, PLLC, Suite 200, 8321 Old Courthouse Road, Vienna, VA, 22182-3817, US

(21) Appl. No.: 09/985,445

(22) Filed: Nov. 2, 2001

(30) Foreign Application Priority Data
Nov. 7, 2000 (JP) 2000-338712

(51) Int. Cl. G06F 15/00

(52) U.S. Cl. 707/513

(57) ABSTRACT

Data items of an XML document are stored in a database. Document “b” of document type “B” that is in accordance with the format of the XML document is received by a receiving circuit. Using type-conversion document “BA”, a document-type conversion circuit converts received document “b” to document “a” of document type “A”. Document “a” corresponds to a record of the database. Data items in document “a” can be stored in the database.

### BACKGROUND OF THE INVENTION

1. Field of the Invention

This invention relates to an apparatus and method for converting a markup language document that is in compliance with a markup language format.

2. Description of the Related Art

It has become possible generally to describe and circulate a variety of information by utilizing markup language such as XML (Extensible Markup Language). Markup language, however, does not take relational databases into account. A markup language document compliant with the format of markup language often cannot be utilized in a database as is.

Further, markup language does not have the functions of a database system, such as search and rearrangement functions. If a search is attempted, a full-text search engine must be utilized. This means that it is difficult to exploit the advantages of markup language.

### DISCLOSURE OF THE INVENTION

Accordingly, an object of the present invention is to make it easy to store data in a database utilizing a markup language document.

Another object of the present invention is to make it comparatively easy to extract the original markup language document in a case where data has been stored in a database by utilizing the markup language document.

An apparatus for converting a markup language document according to a first aspect of the present invention comprises a first reading unit for reading a first markup language document having a first document type in accordance with a markup language format; a second reading unit for reading a conversion document that is for converting the first markup language document, which has been read by the first reading unit, to a second markup language document having a second document type, which is in accordance with the markup language format, and corresponding to a record of a relational database; and a conversion unit (conversion means) for converting the first markup language document, which has been read by the first reading unit, to the second markup language document using the conversion document that has been read by the second reading unit.

The first aspect of the present invention provides also a method suited to the apparatus described above. Specifically, the method comprises steps of reading a first markup language document having a first document type in accordance with a markup language format; reading a conversion document that is for converting the read first markup language document to a second markup language document having a second document type, which is in accordance with the markup language format, and corresponding to a record of a relational database; and converting the read first markup language document to the second markup language document using the read conversion document.

In accordance with the first aspect of the present invention, the first markup language document of the first document type, which is compliant with the format of a markup language document, and the conversion document are read. By using the conversion document, the first markup language document is converted to the second markup language document of the second document type that is compliant with the format of the markup language document and that corresponds to the record of a relational database.

Since the second markup language document obtained as a result of the conversion corresponds to the record of a relational database, it becomes comparatively easy to store data items in a database.

It would be preferable to provide a unit (means) for mapping the second markup language document, which has been obtained by the conversion performed by the conversion unit, to a database.

A second aspect of the present invention extracts an original markup language document in a case where data has been stored in a database in accordance with the first aspect of the present invention. An apparatus for converting a markup language document according to a first aspect of the present invention comprises a first reading unit for reading a first markup language document having a first document type, which is in accordance with the format of a markup language document, and corresponding to a record of a relational database; a second reading unit for reading a conversion document that is for converting the first markup language document, which has been read by the first reading unit, to a second markup language document having a second document type in accordance with the markup language format; and a conversion unit (conversion means) for converting the first markup language document, which has been read by the first reading unit, to the second markup language document using the conversion document that has been read by the second reading unit.

The second aspect of the present invention provides also a method suited to the apparatus described above. Specifically, the method comprises steps of reading a first markup language document having a first document type, which is in accordance with the format of a markup language document, and corresponding to a record of a relational database; reading a conversion document that is for converting the read first markup language document to a second markup language document having a second document type in accordance with the markup language format; and converting the read first markup language document to the second markup language document using the read conversion document.

In accordance with the second aspect of the present invention, the first markup language document of the first document type that is compliant with the format of a markup language document and that corresponds to the record of a relational database is read. By using the conversion document, the first markup language document that has been read is converted to the second markup language document of the second document type compliant with the format of the markup language document.

Accordingly, if data has been stored in a database by utilizing a markup language document, the original markup language document (the second markup language document) can be extracted.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a database system according to a first embodiment of the present invention;

FIG. 2 is a flowchart illustrating the processing of the database system according to the first embodiment;

FIGS. 3 and 4 illustrate an example of a document type;

FIG. 5 illustrates an example of a type-conversion document according to the first embodiment;

FIGS. 6 and 7 illustrate an example of a document type;

FIG. 8 illustrates an example of a database;

FIG. 9 is a block diagram illustrating the electrical configuration of a database system according to a second embodiment of the present invention;

FIG. 10 is a flowchart illustrating the processing of the database system according to the second embodiment; and

FIG. 11 illustrate an example of a type-conversion document according to the second embodiment.

### DESCRIPTION OF THE PREFERRED EMBODIMENTS

(1) First Embodiment

A database system in a first embodiment of the invention converts a document (document “b”), which is in accordance with a document type (document type “B”) adapted to the format of XML (Extensible Markup Language), to a document (document “a”) in accordance with a document type (document type “A”) suited to writing of data to a database. Data item is stored in the database.

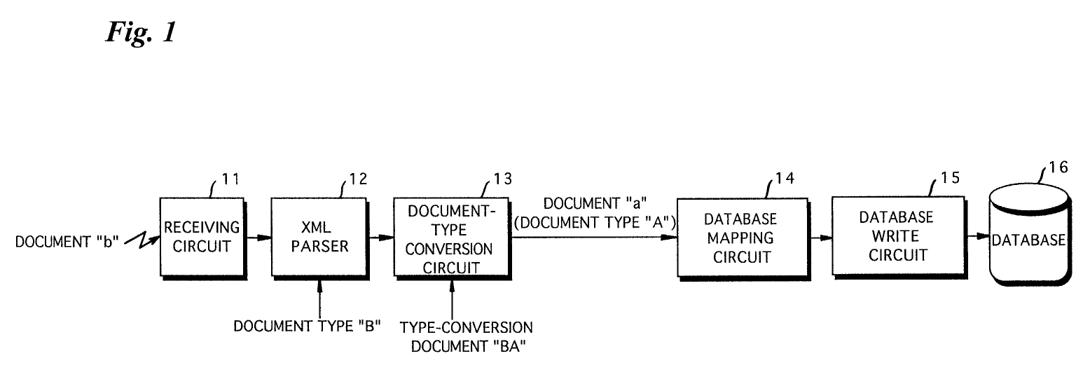

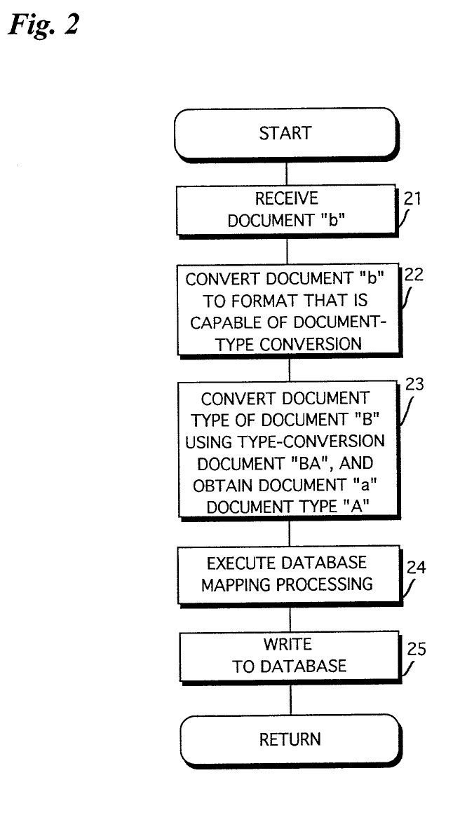

FIG. 1 is a block diagram illustrating the electrical configuration of a database system according to the first embodiment, and FIG. 2 is a flowchart illustrating processing executed by the database system.

First, document “b” (data representing this document), which is in accordance with document type “B”, is received by a receiving circuit 11 (step 21).

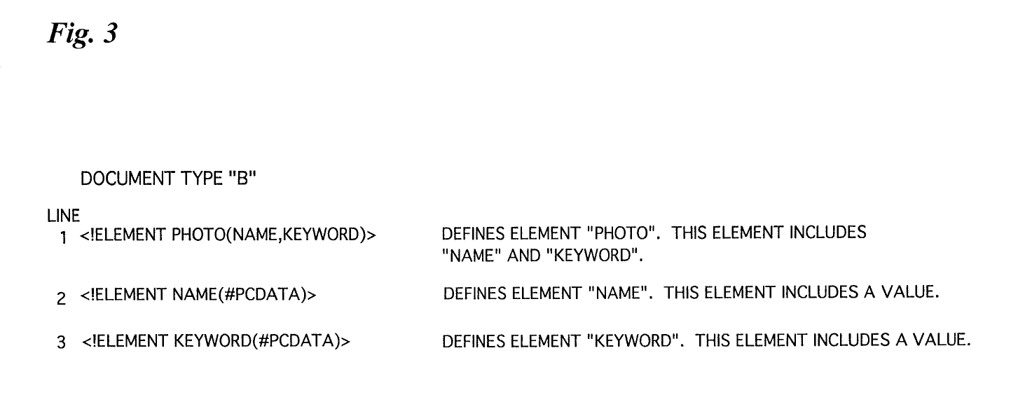

Document type “B” is illustrated in FIG. 3. Document type “B” is the document type of document “b” received by the receiving circuit 11, as mentioned above.

As shown in FIG. 3, the first line of the document type defines an element PHOTO and indicates that this element includes NAME and KEYWORD. The second line defines an element NAME and indicates that this element possesses a value. The third line defines KEYWORD and indicates that this element possesses a value.

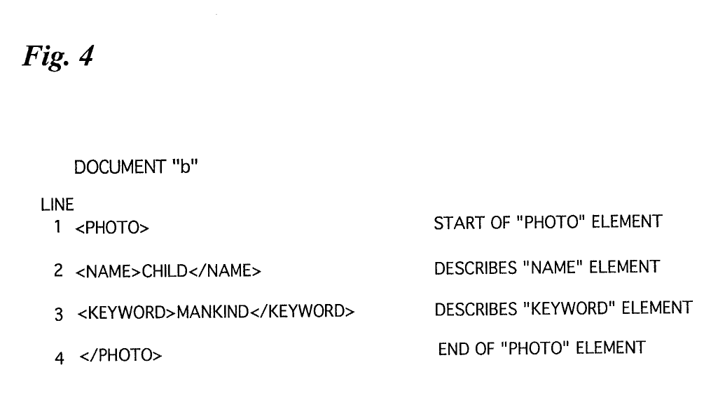

FIG. 4 illustrates document “b”, which is in accordance with document type “B” of the kind shown in FIG. 3.

The first line of this document indicates that start of the PHOTO element, the second line describes the NAME element, the third line described the KEYWORD element and the fourth line indicates the end of the PHOTO element.

When document “b” in accordance with document type “B”is received by the receiving circuit 11, the latter inputs the document to an XML parser 12. Document type “B” (i.e., document data indicative of this document type) also is input to the XML parser 12, which checks to determine whether the entered document “b” complies with document type “B”. If document “b” is in compliance with document type “B”, then the XML parser 12 applies a format conversion (step 22) in such a manner that document “b”will take on a convertible format in a document-type conversion circuit 13. Document “b” that has undergone the format conversion enters the document-type conversion circuit 13.

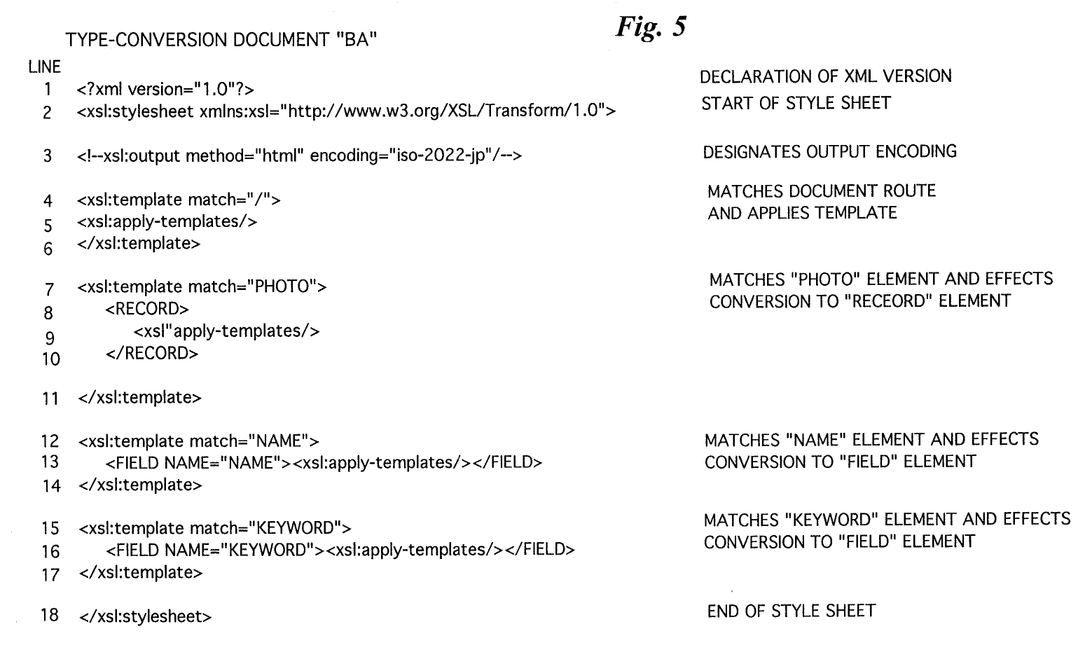

Type-conversion document “BA” shown in FIG. 5 also is input to the document-type conversion circuit 13. Type-conversion document “BA” is for converting document “b” in accordance with document type “B” to document “a” in accordance with document type “A”. Document “a”obtained by the conversion corresponds to a record in a database 16, as will be described later.

As shown in FIG. 5, the first line of type-conversion document “BA” indicates a declaration of the XML version, the second line indicates the start of a style sheet, and the third line indicates the designation of output encoding. The fourth to sixth lines indicate a match with a document route and application of a template. The seventh to 11^{th} lines indicate a match with the PHOTO element and conversion to a RECORD element. The 12^{th} to 14^{th} lines indicate a match with the NAME element and conversion to a FIELD element. The 15^{th} to 17^{th} lines indicate a match with the KEYWORD element and conversion to the FIELD element. The 18^{th} line indicates the end of the style sheet.

As a result of document “b” being converted by the document-type conversion circuit 13 using type-conversion document “BA”, document “a” in accordance with document type “A” (the second document type) is obtained (step 23).

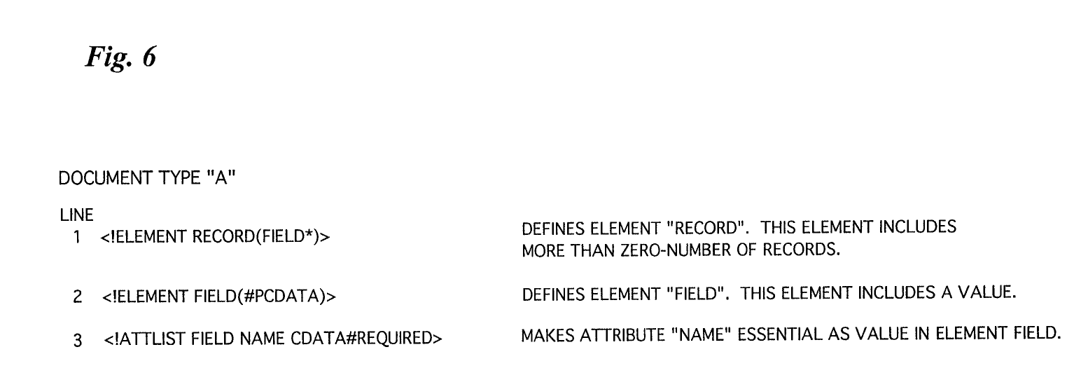

Document type “A” is illustrated in FIG. 6.

The first line of this document type defines the element RECORD and indicates that this element includes more than zero-number of FIELDs. The second line defines the element FIELD and indicates that this element has a value. The third line indicates that an attribute NAME is essential as a value in the element FIELD.

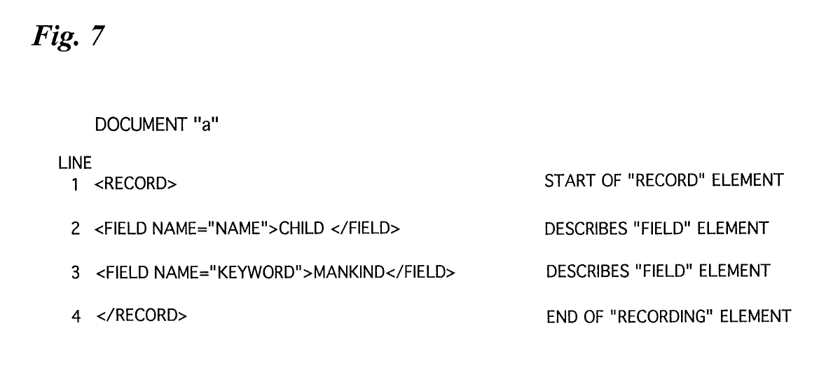

Document “a” compliant with document type “A” shown in FIG. 6 is illustrated in FIG. 7. Document “a” is output from the document-type conversion circuit 13.

The first line of document “a” indicates the start of the RECORD element, the second and third lines indicate descriptions of respective ones of FIELD elements, and the fourth line indicates the end of the RECORD element.

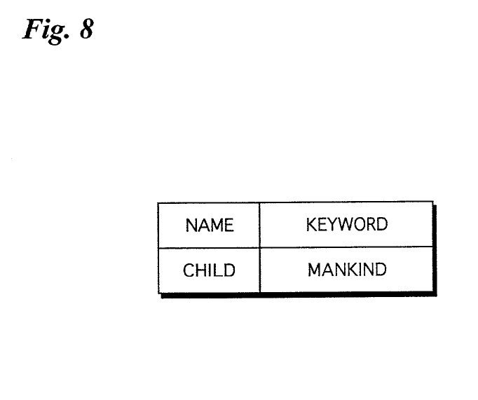

FIG. 8 illustrates an example of a table of database 16. Here “CHILD” and “MANKIND” have been entered as data items.

The data items “CHILD” and “MANKIND” of document “a”are in one-to-one correspondence with the data items “CHILD” and “MANKIND” of the record in the database shown in FIG. 8. Accordingly, the data items can be stored in the database 16.

Document “a” output from the document-type conversion circuit 13 enters a database mapping circuit 14. The latter executes mapping processing in such a manner that the data items of document “a” will be mapped to the respective data items of database 16 (step 24).

The data items that have undergone database mapping are written to the database 16 (step 25) by a database write circuit 15.

Thus, data items specified by a document having a document type that conforms to the XML format can be stored in a database. It is possible to obtain the advantages of processing ease, such as database search and rearrangement, while exploiting ease of circulation by a markup language document such as an XML document. It becomes comparatively easy to transfer data between systems of different types.

(2) Second Embodiment

A database system according to a second embodiment of the invention converts a document (document “a”), which is in accordance with a document type (document type “A”) suited to a database, to a document (document “b”) in accordance with a document type (document type “B”) adapted to the XML format. That is, this embodiment performs a conversion that is the reverse of that of the database system in the first embodiment.

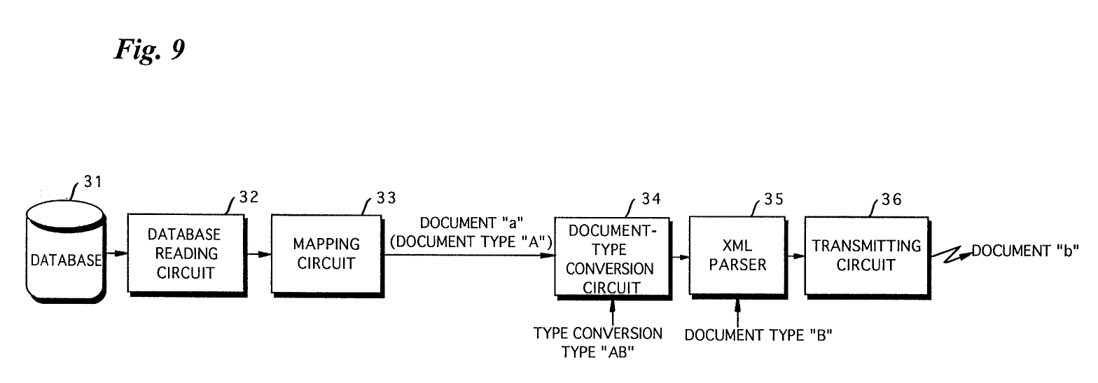

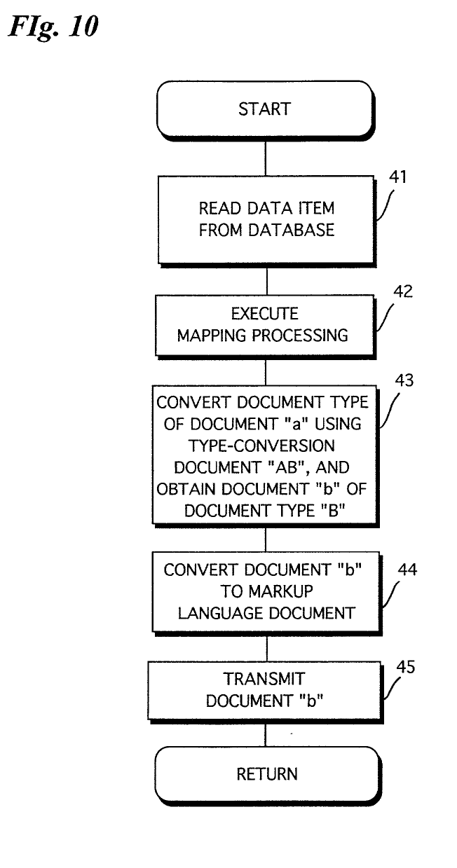

FIG. 9 is a block diagram illustrating the electrical configuration of a database system according to the second embodiment, and FIG. 10 is a flowchart illustrating processing executed by the database system of the second embodiment.

Document type “A” (FIG. 6), document “a” (FIG. 7), document type “B” (FIG. 3) and document “b” (FIG. 4) used here are the same as those of the first embodiment.

Data items that have been recorded in a database 31 in the manner described above are read by a database reading circuit 32 (step 41). Mapping processing is executed by a mapping circuit 33 to obtain document “a”, which is in accordance with document type “A” (step 42). Obtained document “a” is applied also to a document-type conversion circuit 34.

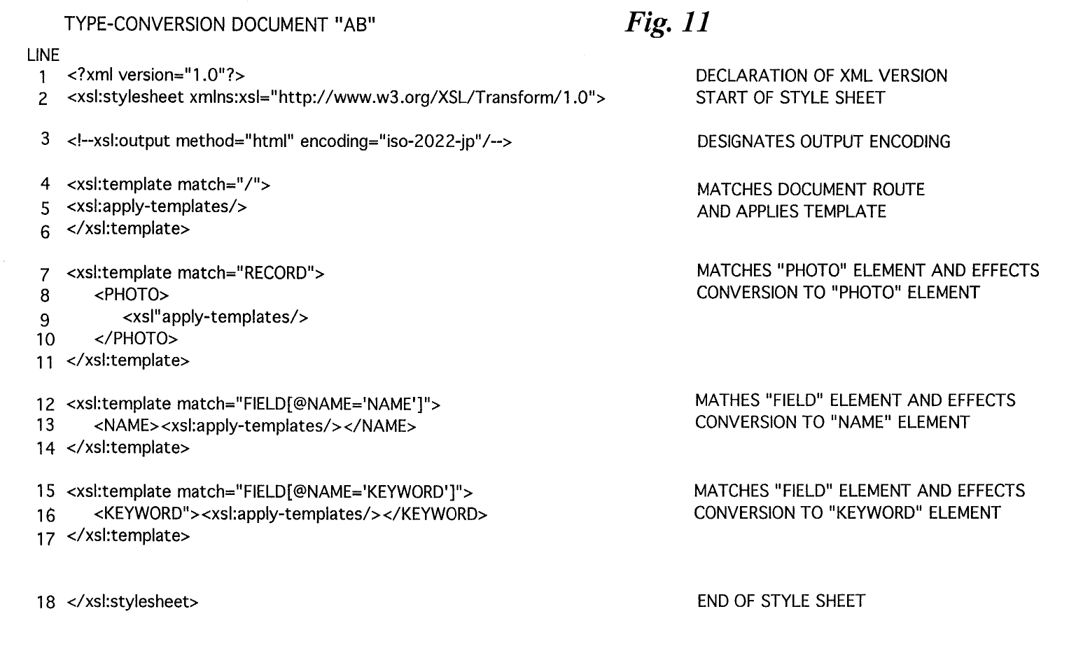

Type-conversion document “AB” illustrated in FIG. 11 also is input to the document-type conversion circuit 34. Type-conversion document “AB” is for converting document “a” compliant with document type “A” to document “b”compliant with document type “B”.

As shown in FIG. 11, the first line of type-conversion document “AB” indicates a declaration of the XML version, the second line indicates the start of a style sheet, and the third line indicates the designation of output encoding. The fourth to sixth lines indicate a match with a document route and application of a template. The seventh to 11^{th} lines indicate a match with the RECORD element and conversion to the PHOTO element. The 12^{th} to 14^{th} lines indicate a match with the FIELD element and conversion to the PHOTO element. The 15^{th} to 17^{th} lines indicate a match with the FIELD element and conversion to the KEYWORD element. The 18^{th} line indicates the end of the style sheet.

As a result of document “a” being converted by the document-type conversion circuit 34 using type-conversion document “AB”, document “b” in accordance with document type “B” is obtained (step 43). Document “b” output from the document-type conversion circuit 34 is applied to an XML parser 35. The XML parser 35, to which document type “B” also is input, checks to determine whether entered document “b” is in accordance with document type “B”. If document “b” is in accordance with document type “B”, then the XML parser 35 converts document “b” to a markup language document (step 44) in such a manner that it can be transmitted from a transmitting circuit 36.

Document “b” that has been converted to the markup language document is transmitted by the transmitting circuit 36 to, e.g., a client computer (step 45).

Thus, data items that have been written to the database 31 can be extracted in the form of a markup language document.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for converting a markup language document, comprising:
a first reading unit for reading a first markup language document having a first document type in accordance with a markup language format;
a second reading unit for reading a conversion document that is for converting the first markup language document, which has been read by said first reading unit, to a second markup language document having a second document type, which is in accordance with the markup language format, and corresponding to a record of a relational database; and
a conversion unit for converting the first markup language document, which has been read by said first reading unit, to the second markup language document using the conversion document that has been read by said second reading unit.

2. The apparatus according to claim 1, further comprising a unit for mapping the second markup language document, which has been obtained by the conversion performed by said conversion unit, to a database.

3. A method of converting a markup language document, comprising the steps of:
reading a first markup language document having a first document type in accordance with a markup language format;
reading a conversion document that is for converting the read first markup language document to a second markup language document having a second document type, which is in accordance with the markup language format, and corresponding to a record of a relational database; and
converting the read first markup language document to the second markup language document using the read conversion document.

4. An apparatus for converting a markup language document, comprising:
a first reading unit for reading a first markup language document having a first document type, which is in accordance with the format of a markup language document, and corresponding to a record of a relational database;
a second reading unit for reading a conversion document that is for converting the first markup language document, which has been read by said first reading unit, to a second markup language document having a second document type in accordance with the markup language format; and
a conversion unit for converting the first markup language document, which has been read by said first reading unit, to the second markup language document using the conversion document that has been read by said second reading unit.

5. A method of converting a markup language document, comprising the steps of:
reading a first markup language document having a first document type, which is in accordance with the format of a markup language document, and corresponding to a record of a relational database;
reading a conversion document that is for converting the read first markup language document to a second markup language document having a second document type in accordance with the markup language format; and
converting the read first markup language document to the second markup language document using the read conversion document.
